(19) United States
(12) Patent Application Publication
(10) Pub. No.: US 2013/0259403 A1
(43) Pub. Date: Oct. 3, 2013

(54) FLEXIBLE EASY-TO-USE SYSTEM AND METHOD OF AUTOMATICALLY INSERTING A PHOTOREALISTIC VIEW OF A TWO OR THREE DIMENSIONAL OBJECT INTO AN IMAGE USING A CD,DVD OR BLU-RAY DISC

(71) Applicant: OLUWATOSIN OSINUSI, Bethesda, MD (US)

(72) Inventor: OLUWATOSIN OSINUSI, Bethesda, MD (US)

(21) Appl. No.: 13/854,964

(22) Filed: Apr. 2, 2013

Related U.S. Application Data
(60) Provisional application No. 61/619,930, filed on Apr. 3, 2012.

(51) Int. Cl. G06K 9/32

(52) U.S. Cl. CPC G06K 9/3208
USPC 382/294

(57) ABSTRACT

Certain aspects are directed to a system for augmenting an existing digital image with the image of an object inserted with the proper scale and perspective for the purpose of visualization. The system includes an interface for inputting one or more images of the scene and methods for obtaining any of camera calibration, camera orientation and partial or full metric reconstruction of the scene. The image(s) of the scene can be required to be rendered with an optical disc such as CD, DVD or Blu-Ray placed on flat, identifiable rectangular surface within the scene.

### CROSS-REFERENCE TO RELATED APPLICATIONS

This application claims priority to U.S. provisional Application Ser. No. 61/619,930 filed Apr. 3, 2012 and titled “Flexible easy-to-use system and method of automatically inserting a photorealistic view of a two or three dimensional object into an image using a CD, DVD or Blu-ray disc.” The contents of said application are hereby incorporated by reference.

### TECHNICAL FIELD

The present invention pertains generally to the field of geometric computer vision and more specifically (although not necessarily exclusively) to the application area of augmented reality.

### BACKGROUND

Embodiments of the present subject matter can provide methods and systems for augmenting the image of an arbitrary indoor scene by inserting the images of one or more objects. The images of the object(s) can be inserted into the image of the scene with the proper scale and perspective. The image of the scene can be augmented in a manner that is consistent with the visual effect that would have been produced had the object been present in the scene in the desired pose prior to the image of the scene being rendered. This method can be applied without prior knowledge of the internal calibration parameters of the imaging camera or its position with respect to the scene. The system can be used without the need of special equipment or skill.

A camera and a standard sized optical disc can be the only tools utilized for this method. A standard sized optical disc is an circular optical disc of standardized size manufactured to high precision. Non-limiting examples of such discs are CDs, DVDs and Blu-ray discs. The optical disc can be required to be placed flat on a contrasting, preferably uniform colored rectangular surface that is coincident with or parallel to the ground plane of the indoor scene. The dimensions of the rectangle can be unknown. The rectangle is required to be identifiable and large enough to enclose the optical disc. In some embodiments of the system, multiple discs can be used. In one aspect, an optical disc can also be attached to a vertical surface within the scene.

The system can be hosted entirely on a single computing platform or distributed across server and client applications. The client application can be run on a desktop or notebook computer, tablet computer or mobile handset. The system can contain memory on which the methods of the system can be stored and from which methods of the system can be retrieved. Certain methods of the system may be implemented on specialized processors such as Digital Signal Processors (“DSP”), Field Programmable Gate Arrays (“FPGA”) or Application specific Integrated Circuits (“ASIC”).

Systems and methods that can accurately and reliably determine camera internal calibration parameters and camera pose as well as obtain the metric reconstruction of the imaged scene without need of specialized equipment and user knowledge of any dimensions within the scene are desirable and useful. In addition, it is desirable that such systems be able to apply the calibration, pose and metric information obtained to further enhance or augment one or all the digital images from which the information was obtained.

### SUMMARY

Certain aspects and features of the present invention are directed to augmenting an image of a scene.

In one aspect, an image augmentation system is provided. The system can include a web portal from which images may be uploaded and an image processing system.

In another aspect, a method is provided that can allow determination of the internal calibration parameters of the image rendering device, the pose of the image rendering device relative to the scene and the Euclidean scale of the scene.

In another aspect, an additional method is provided that can allow a two or three dimensional model of an object to be projectively mapped into the scene with the proper scale and perspective using the results of the method in [0009] above.

### BRIEF DESCRIPTION OF DRAWINGS

FIG. 1 shows an example of central projective mapping of an optical disc placed on a flat rectangular surface.

FIG. 2 shows an optical disc placed on a flat rectangular surface in a Euclidean coordinate frame.

FIG. 3 shows the object of FIG. 2 under perspective distortion in the projective coordinate frame of an image rendering device.

### DETAILED DESCRIPTION

The convergence of affordable high resolution digital photography, ubiquitous broadband and wireless data communications and new computing platforms such as smart-phones and tablet computers has enabled a plethora of applications. The invention disclosed herein mainly (but not exclusively) targets the retail sector—in particular, retailers of furnishings, indoor fittings, window dressings etc. It can allow a prospective customer to insert a photorealistic view of an object into an existing image of an arbitrary indoor scene to assist him/her in visualization and in making a purchase decision. Such items include but are not limited to place rugs, center tables, side tables, light fittings, window fittings, trim fittings, chairs, sofas, credenzas, floor tiles, murals, wall paper patterns, framed wall paintings etc. Such a system can serve as a driver of internet traffic for a retailer and give such retailer a competitive advantage in securing a sale from a customer.

The user of the system would take a digital image of the scene into which the insertion of the object(s) is desired. This image can be procured with a standalone digital camera, camera enabled mobile handset, tablet computer, digital video camera or can even be a scanned copy of a film image. For some aspects of the system, at least two ancillary images may also be rendered with the same camera settings as the main image but from different camera positions and/or orientations. Prior to taking these images, it can be required that an optical disc be placed on a flat rectangular surface which is itself placed either on the ground plane of the scene or on such a plane as a center table that is parallel to the ground plane. The optical disc can be required to be placed on the flat rectangular surface with the reflective side upwards.

The digital image and any ancillary images rendered would be required to show the optical disc and the flat rectangular object.

The digital image(s) rendered can be uploaded or otherwise entered to the system. In the case of a remotely located system, this can be done over the internet or by transmitting the image wirelessly via a mobile handset or wireless enabled tablet computer. The user can carry out a series of steps that can culminate in a two or three dimensional model of the object(s) whose views are desired (“the insertion object(s)”) being projectively mapped into the image. This can be accomplished irrespective of whether or not camera calibration information, location and orientation information are available. Details of this insertion process are covered in the items below.

Camera calibration information, if available can be uploaded or otherwise provided along with the image. This information can be available as metadata associated with the image file or can be known by the system user. The information can include (but is not limited to) any of the following: camera model; focal length; skew factor; pixel aspect ratio; radial distortion parameters. Camera orientation if available can be uploaded or otherwise entered into the system. Camera location with respect to the scene can be uploaded or otherwise provided if available. An embodiment of the system can have the ability to retrieve and apply such information in the instance that the image rendering device or user has the ability to provide the information in a publically available or otherwise known format. The system can be flexible with respect to the amount of information required and can equally function effectively in the absence of any information accompanying the image.

Subsequent to the image(s) being uploaded or otherwise entered into the system, the system can prompt the user to select the four corners of the flat surface in at least one of the images. The system can assist the user in pixel selection by having a magnify and zoom capability. After this initial corner identification, the system can automatically identify the same corners in the other images. It is necessary for the proper functioning of the system that all four corners of this surface be visible in the main and any ancillary images. Possible examples of the rectangular surface are printing paper, large envelopes, hardcover books and CD cases. The only requirement on this surface is rectangular dimensions that are large enough to fully enclose the optical disc within its boundaries. Uniformity in color and contrast with the surface of the optical disc can also desirable. The user selection of corners described can assist the system to accurately detect the outline of the optical disc enclosed by the rectangle in each image using digital edge detection algorithms that would be familiar to one skilled in the art. This outline will generally be elliptical in shape. The edge detection algorithm will return the border pixels of this ellipse. These points can be fitted to an ellipse giving the boundary trace of the optical disc in the image at sub-pixel resolution.

A subset of the pixel coordinates of the boundary of the optical disc in each image can serve as a calibration template to calibrate the camera used to obtain the images. The image of the optical disc can also used to obtain metric information about the scene since the optical disc is of standard size (diameter 12 cm) and manufactured to high precision. However, in contrast to a typical calibration object, the optical disc is un-patterned and specific Euclidean points along and within its' boundaries are not visually identifiable. The methods described herein overcome these obstacles to achieve accuracy, robustness and ease of use. The processes of camera calibration and metric re-construction of the scene allow photorealistic augmentation of the original image. Further details of the calibration algorithm are presented in [0025] to [0040].

After calibration, the system can have the necessary knowledge of the scale of the scene, the internal parameters of the camera and the pose of the camera in relation to the scene in the main image. The system can contain a menu from which a user can select the desired object of insertion to be placed in the image. In the instance of a two-dimensional model such as a place rug, full camera calibration can use a single image. Metric reconstruction of just the ground plane using the known dimensions of the optical disc can be obtained.

For each possible insertion object, the system can contain a high resolution three-dimensional photographic model. Such a model can amongst other methods be developed using a stereo camera rig in a manner familiar to one skilled in the art. For some objects such as floor tiles, floor fittings, murals and wall paper patterns it can only be necessary to have a two dimensional model available.

In some aspects, the methods of the system can support metric scaling of the model before insertion depending on the particular characteristics of the desired insertion. Thus in instances where the object is custom or made-to-fit, the customer will be able to preview it in the desired scale relative to the scene.

In some aspects, the methods of the system can support the erasure of objects from the image prior to object insertion. For example: the image of a sofa can be removed from the image of a living room scene prior to the insertion of another sofa using the system. The calibration objects can also be removed from the final image. The system can texture map the scene on object removal and prior to new object insertion.

An embodiment of the system can also enable the user to specify the desired insertion object as background or foreground relative to other objects in the scene. This information can assist the system in computing occlusions. In other instances, the system can independently make that determination by making certain assumptions. For example: in a typical enclosed indoor scene, the outer walls and floor form a concave hull that is in the background of any other indoor object thus allowing them to be distinguished from other objects in the scene. An enclosing “box” can be constructed around an occluding object using a click and drag feature and the orientation information derived from the camera calibration. The system can then isolate the object using well known image segmentation algorithms and calculate its dimensions using the calibration information available. The system can thus determine what parts of the object to be inserted can be occluded.

A camera can generally be modeled as a linear projective mapping from the 3D Euclidean space of the scene to the 2D projective space of the image plane such that

x=PX (1)

Where: X is a 4-component homogeneous vector representing a point in the three-dimensional scene and defined in the Euclidean coordinate frame of the scene.

x is a 3-component homogeneous vector representing a point in the two-dimensional image plane. It is defined in the image coordinate frame with origin at the projective center of the camera.

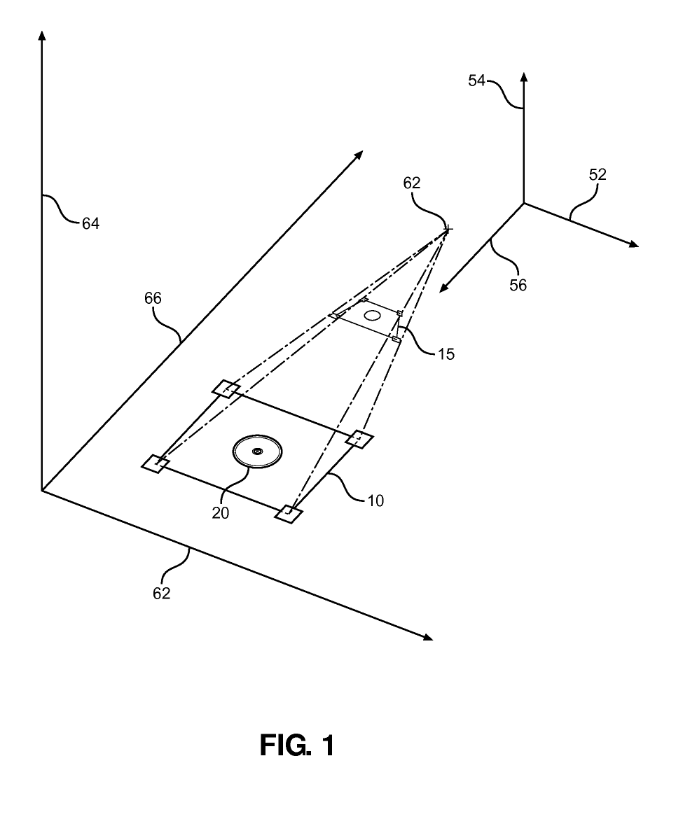

P is a 3×4 homogeneous camera matrix that performs the mapping. FIG. 1 shows such a mapping of an object 10 about the camera center 62. The scene X-Y-Z axes is represented by the axes system 62-66-64. The camera X-Y-Z coordinate system is represented by the system 52-54-56 centered at projective center 62. The image plane is coincident with the X-Y plane 52-54.

Matrix P can be decomposed as P=K[R|t] (2)

Where K is a 3×3 matrix representing the internal calibration parameters of the camera; R is the 3×3 rotation matrix that rotates the world coordinate axes 62-66-64 into alignment with the coordinate frame 52-54-56 centered at the camera center 62; t is the translation vector that translates the origin of the world coordinate frame to the camera center 62.

The 3×3 internal calibration matrix K can be further decomposed as:

$$K = [ \begin{matrix}{fp}_{x} & s & {u}_{o} \\ 0 & {fp}_{y} & {v}_{o} \\ 0 & 0 & 1\end{matrix} ] \qquad ( 3 )$$

where f is the focal length of the camera, pₓ and p_{y} represent the pixel resolution per unit of f in the x and y directions respectively; uₒ and vₒ are the x and y pixel coordinates of the camera principal point respectively; s represents the skew factor of the camera. The radial distortion characteristic of the imaging lens is superimposed on this model so that an image point can deviate from that predicted by the projective mapping above along radial lines emanating from a point known as the center of radial distortion

FIG. 1 show an optical disc 20 placed on a flat rectangular surface 10. Both disc and rectangle are projected along lines of central projection to the image plane 15. It can be shown that a 3-D to 2-D projective mapping induces a planar homography on any plane within the scene.

Camera calibration is the process of estimating the calibration matrix and the radial distortion parameters of the camera. The list of camera calibration techniques is extensive and ranges from photogrammetric methods to more recent methods based on projective geometry and computer vision. In reference [1], Zhang describes a method for calibration using multiple images of a planar calibration pattern. This method utilizes the fact that a projective transformation from 3D to 2D induces a planar homography on any plane within the 3D scene. By estimating this homography for multiple planes or multiple views of a plane, the camera matrix can be derived. The planar calibration object used is usually a black and white checkerboard pattern with accurately known dimensions. The corner points of this plane can be identified in the image with sub-pixel accuracy using well developed corner extraction techniques. The set of matching world and image coordinates are used to estimate the planar homography for each image allowing the overall camera matrix to be developed. Several variations of this algorithm have subsequently appeared in the literature.

In the method described in this invention, a standard optical disc such as a CD, DVD or Blu-Ray disc serves as the planar calibration pattern. A well known result in projective geometry is that a conic section is mapped to another conic section by a planar projective transformation. In this case, the Euclidean optical disc—being a closed conic—is mapped to an ellipse whose parameters can be found by fitting the image conic to the pixels returned by an edge detection algorithm. This projective mapping and the ensuing radial distortion alter the linear and angular relationships of points along the circumference of the imaged disc. One side of a standard optical disc is reflective and uniformly gray in color and the other side can have a arbitrary pattern on it. The absence of visible or known markings on the disc and the distortion effects from projection make it impossible to visually or algorithmically identify Euclidean coordinates of points on the calibration object directly from its' image. The Euclidean coordinates of points on the circumference of the optical disc are obtained as described below using the techniques of geometric computer vision primarily by taking advantage of the fact that the optical disc is a circle of known dimension.

The first step in this method is the coarse estimation of the vanishing line of the plane containing the disc in each image. The term “coarse” is used because this line can be iteratively refined. The vanishing line of a plane can be found as the line connecting any two vanishing points on the plane. A vanishing point on a plane can itself be determined by tracing out the intersection of a set of parallel lines that are coincident with or parallel to the plane. The four corners of the rectangle on which the disc is placed can be used for this purpose. These points are user selected at pixel resolution and contain user selection error and quantization error.

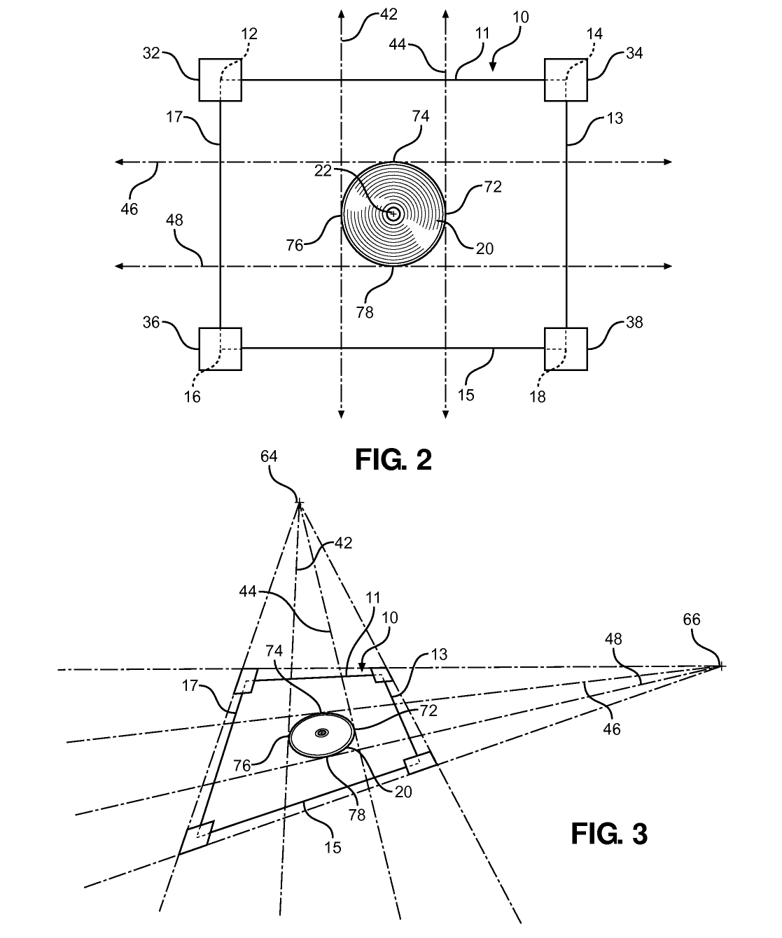

FIG. 2 shows the optical disc 20 and flat rectangular surface 10 in a Euclidean frame.

The four corners of the Euclidean rectangle are shown as 12, 14 16, 18. The uncertainty in the position of each of the vertices is illustrated by the squares 32, 34, 36, 38 shown overlaid on each of the vertices. Two pairs of orthogonal tangents to the circle 20 are shown. The tangent pairs 42/44 and 46/48 are parallel to the sides 13/17 and 11/15 of the rectangle 10 respectively.

FIG. 3 shows the optical disc 20 and flat rectangular surface 10 under the effects of perspective distortion in the image plane. FIG. 3 ignores the effect of radial distortion. Radial distortion can be resolved either prior to or in concert with the camera calibration, pose determination and metric reconstruction and as part of the method of the system disclosed herein; In FIG. 3, it can be seen that parallel lines on the image plane can converge to a finite point on the plane under the projective mapping. Two such points 64 and 66 are shown for the two directions of the sides of the rectangular surface. The line defined by any two such vanishing points is known as the vanishing line of the plane and would be familiar to one skilled in the art.

The vanishing points and line in FIG. 3 are a finite representation of the line and points at infinity in the Euclidean world where it can be observed that parallel line never meet except at infinity.

From FIG. 3, one way to obtain the vanishing points and by extension the vanishing line would be to trace out the lines along each of the sides of the rectangular surface and obtain points 64 and 66. This can however complicated by the presence of user selection error.

The method can refine the selection of Euclidean points 12, 14, 16 and 18 in the image. The method can perform this action based on the following observations. From FIG. 2, it can be observed that in the Euclidean world, the line through the points of contact 72 and 76 of tangent pair 42 and 44 with the circle 20 is orthogonal to the tangent pair 42 and 44 and parallel to the sides 11 and 15 of the rectangle. A similar relationship holds for tangent pair 46 and 48 and points of contact 74 and 78. This is due to the fact that the optical disc is a circle. Thus, line 72-76 is orthogonal to line 74-78 where the notation line x-y refers to the line defined by two points x and y. The line t₁-t₂ through the points of contact of a circle tangent pair {t₁, t₂} is the polar line of the intersection point of the tangent pair {t₁, t₂} with respect to the circle. Rectangle sides 13, 17 and tangents 42 and 44 intersect at such a point on the vanishing line of the plane of the rectangle surface and optical disc. Rectangle sides 11, 15 and tangents 46 and 48 likewise intersect on the vanishing line at a different point. From the foregoing, these intersection points are on each other's polar lines with respect to the circle 20. A pair of points that are on each other's polar lines with respect to a conic are described as conjugate points with respect to said conic. Thus the meeting points of 42/44 and 46/48 are conjugate with respect to the conic 20. The meeting points of parallel tangent pairs 42/44 and 46/48 are the points at infinity in their respective directions on the Euclidean plane containing the rectangle 10. Euclidean points at infinity are indicated on the projective plane p² are indicated by having the third projective component equal to 0. It can be shown that Euclidean conjugacy between infinite or vanishing points with respect to a circle is possible if and only if the vanishing points are in orthogonal directions as is the case with the intersection points of tangent pairs 42/44 and 46/48 in FIG. 2. Conjugacy between two points x,y with respect to a conic C is denoted by the expression:

y^{y}Cx=0 (4)

Where C is the 3×3 symmetric homogeneous matrix of the conic and l=Cx is the polar line of the pointx. In general, the matrix C defines the conic as the set of points x^{T}Cx=0. Under a linear projective point transformation x′=Hx the conic transforms as the conic C′=H^{-T}CH⁻¹. Expressing equation (4) in the transformed point space gives x′=Hx:

y^{T}H^{T}H^{-T}CH⁻¹Hx=0 (5)

From equation (5), the Euclidean conjugate relationship between the intersection points of tangent pairs 42/44 and 46/48 described in [0032] is preserved by a linear projective point mapping x′=Hx such as that from the plane of FIG. 2 to that of FIG. 3. This suggests that one way to improve the accuracy in the selection of the images of points 12, 14, 16 and 18 is to find the closest point to each of the user selected corner points of rectangle 10 such that the vanishing points resulting from fitting those points to an enclosed quadrilateral (intersection points of opposite sides of the imaged rectangle) satisfy the conjugate relationship. The system can minimize the following objective function defined this: In each image j:

Minimize Σᵢ|Rᵢⱼ^{c}−Rᵢⱼ|² subject to the constraints V₁ⱼ^{T}C′ⱼV₂ⱼ=0

The equivalent statement would be: In each image j, find the image points Rᵢⱼ^{c} closest in Euclidean distance to the 4 user selected corner points Rᵢⱼ such that the points V₁ⱼ and V₂ⱼ defined by the intersection of opposite sides of the closed quadrilateral so obtained are conjugate with respect to the imaged conic C′ⱼ of the circleC.

In the statements above:

Rᵢⱼ: {i=1 . . . 4} are the four user selected corner points of the rectangular surface in image j with R₁ occupying the top left corner and the points Rᵢⱼ: {i=2 . . . 4} labeled in ascending order of i in a clockwise direction.

In FIG. 1, points 12,14,18,16 would correspond to i=1,2,3,4 respectively.

Rᵢⱼ^{c} Is the “corrected” point corresponding to Rᵢⱼ that minimizes the objective function above.

V₁ⱼ=(R₁ⱼ^{c}×R₄ⱼ^{c})×(R₂ⱼ^{c}×R₃ⱼ^{c}) and V₂ⱼ=(R₁ⱼ^{c}×R₂ⱼ^{c})×(R₃ⱼ^{c}×R₄ⱼ^{c}) are the intersection points defined by the “corrected” rectangular points. The symbol × represents vector cross multiplication on homogenous 2D pixel coordinates in each image.

L₁ⱼ=C′ⱼV₁ⱼ and L₂ⱼ=C′ⱼV₂ⱼ represents the polar lines of the vanishing points V₁ⱼ and V₂ⱼ and are orthogonal. However pairs of non-vanishing points can also be conjugate with respect to the image conic C′ⱼ. Thus after finding conjugate pairs V₁ⱼ, V₂ⱼ that minimize the objective function above, further checks must applied to verify that the sides of the image quadrilateral do in fact represent parallel lines within the projective frame of the image.

Many methods are available to find the conjugate points that are defined by the region of uncertainty placed around each of the user selected vertices. One method that can be used to perform a constrained optimization of the objective function defined in [0033]. An exhaustive search within the space defined by the uncertainty regions can also be carried out. This search can be conducted “coarsely” at pixel resolution to return a number of candidates which can be further refined at sub-pixel resolution. The result is pairs of conjugate points with respect to the image conic. These pairs can then be tested further for Euclidean orthogonality.

Each pair of conjugate points above defines a line. The method of the system can involve the following steps to verify that this line is the vanishing line of the scene plane. The intersection of the image conic with the line defines the circular points within the projective frame of the image. The circular points are a pair of complex points on which all circles are incident. In the Euclidean coordinate frame they have the canonical form I=[1 i 0]^{T} and J=[1 −i 0]^{T}. The projective mapping preserves the intersection of I and J with the circle of the optical disc.

The method can find the image of the circular points and determine the conic dual of the circular points to within an similarity. The conic dual of circular points is a degenerate line conic made up of the two circular points both in the Euclidean frame and the coordinate frame of the image. In Euclidean conic geometry, this conic dual of circular points is defined as:

IJ^{T}+JI^{T} (6)

In a Euclidean coordinate frame, I=[1 i 0]^{T} and J=[1 −i 0]^{T}. The conic dual of circular points is given by the 3×3 matrix by:

$${C}_{∞} = [ \begin{matrix}1 & 0 & 0 \\ 0 & 1 & 0 \\ 0 & 0 & 0\end{matrix} ] \qquad ( 7 )$$

It can be shown that a line conic C, under a linear projective point transformation H, transforms to another line conic as

C′=HCH^{T} (8)

It can further be shown that the Euclidean conic dual of circular points C is invariant to a similarity. The linear projective transformation H can expressed as H=H_{S}H_{A}H_{P}, where H_{S} is a similarity transformation, H_{A} is an affine transformation and H_{P} is a projective transformation. From equation (8),

C_{∞}′=H_{P}H_{A}H_{S}C_{∞}H^{T}_{S}H^{T}_{A}H^{T}_{P} (9)

H_{S}, the similarity component of H is absorbed into C_{∞} and is irrecoverable from C_{∞}′. Thus H can only be recovered from C_{∞}′ to within a similarity. Thus equation (9) can be re-stated as:

C_{∞}′=H_{P}H_{A}C_{∞}H^{T}_{A}H^{T}_{P} (10)

The method can decompose the image conic dual of circular points C_{∞}′ as:

C_{∞}′=H′C_{∞}H′^{T} (11)

to give the transforming homography H′ to within a similarity. The inverse of this homography (equal to H^{T}_{A}H^{T}_{P})⁻¹ is applied to the image of the conic and will yield a circle if the image conic dual of circular points is indeed correct. Thus one way to test a pair of circular points in the image is to apply the reverse projective transformation H′⁻¹ that the points yield from decomposing the implied conic dual of circular points to the image of the optical disc and fitting the best circle fit to the resulting points. The pair of conjugate points within the uncertainty region that yields the best circle fit gives the vanishing line of the Euclidean X-Y plane within the image. Metric information on the ground plane from absolute lengths to angles is then available from the combination of the vanishing line and the known dimensions of the optical disc.

The system can use knowledge of the vanishing line of the X-Y plane in each image to find the conic dual of circular points. Metric information can be obtained from the conic dual of the circular points. The conic dual was previously determined to within a similarity. It can be re-calculated without ambiguity using the vanishing line information and knowledge of the Euclidean scene; namely that the image conic represents a Euclidean circle and that conjugate vanishing points represent orthogonal directions.

For any pair of lines l and m that are orthogonal in the Euclidean coordinate frame, it can be shown that l^{T}C_{∞}m=0. This relationship holds regardless of the projective frame in which it is expressed. Thus a pair of orthogonal Euclidean lines places a constraint on C_{∞}.

The conic dual of circular points can be obtained from the images of five or more pairs of Euclidean orthogonal lines. As described above in [0032], orthogonal lines are the polar lines of points that are conjugate with respect to the conic. A minimum of five orthogonal lines is required. For any point on the vanishing line, the system can determine it conic conjugate by intersecting the polar line of the point with the vanishing line of the plane. The polar line of the conic conjugate point can be obtained. The system can use multiple pairs of such lines to solve for the conic dual of circular points. Methods available to solve for the conic dual of circular point within the image given pairs of orthogonal lines would be familiar to one skilled in the art.

The image conic dual of circular points contains metric information from which the Euclidean coordinates of points on the boundary of the optical disc can be derived. The Euclidean angle θ between any two points x and y on the conic boundary can be determined from the relationship:

$$Cos θ = \frac{{l}^{T} {C}^{∞} m}{\sqrt{( {l}_{1} + {l}_{2} ) + ( {m}_{1} + {m}_{2} )}} \qquad ( 10 )$$

Where the lines l=[l₁ l₂ l₃] and m=[m₁ m₂ m₃], represents the polar lines of the conic conjugate points of x and y respectively.

The system can determine the angular distance of the conic boundary points from a reference point to give two dimensional Euclidean coordinates for the boundary points. The system can utilize the known dimensions of the optical disc to transform the angular distance of any point on the conic boundary from the reference point on the conic boundary to two dimensional rectilinear Euclidean coordinates. This method can lead to a set of matching real world and image coordinates for the image conic in each of the at least one images rendered. The techniques available to solve for the planar homography mapping the optical disc to its image in each of the images given matching Euclidean and image coordinates is well known to one skilled in the art. The system can solve for the planar homography between the optical disc plane and the image plane in each of the at least one images.

For j images rendered of the scene where j≧3, the system can utilize the homographies H₁, . . . , Hⱼ of the images 1, . . . , j respectively to obtain the internal camera calibration and the pose of the camera relative to the ground plane within each scene. This process is described in reference (1).

Real camera devices may not have a completely linear model due to the effects of radial lens distortion. This distortion effect can be superimposed on the linear transformation of equation (2) and can result in a distortive displacement of the image point resulting from equation (2) along radial lines from a point known as the center of radial distortion. In addition, there can be tangential component to the distortion. Radial distortion is often modeled as a polynomial of radial distance:

D(r)=1+k₁r+k₂r²+k₃r³+ . . . (11)

In equation (11), D(r) represents the radial distortion as a function of distance r from the center of radial distortion. The most visible effect of radial distortion of the bending of straight lines in a image particularly those that lie towards the periphery of the image plane.

Several techniques are available for estimating the radial distortion parameters of a camera that would be known to one skilled in the art. Among the ways that radial lens distortion can be corrected is by observing the outline of putatively straight edges particularly those that lie towards the periphery of the images. The edges of the rectangular object can help to serve this purpose by presenting straight real world edges in the image that can examined for the effects of radial distortion. By fitting a model of radial distortion such as but not limited to equation (11) to the edges of the flat rectangular surface in all the images, a radial distortion model can be obtained model for imaging device. The edges of the rectangular object can be detected by image edge detection techniques that would be familiar to one skilled in the art. This corrective model can be applied to all the images before the application of the method described above. The model can be applied iteratively whereby the radial distortion parameters kᵢ may be solved with the camera internal calibration parameters over multiple iterations with each successive iteration improving the accuracy of the result.

### REFERENCES

1. Z. Zhang, “A flexible new technique for camera calibration”, IEEE Transactions on Pattern Analysis and Machine Intelligence, 22(11): 1330-1334, 2000
2. Richard Hartley and Andrew Zimmerman, “Multiple View Geometry in Computer Vision”, 2 ed. Cambridge University Press.

What is claimed is:

1. A system configured to obtain any combination of camera internal calibration, camera pose and Euclidean scene reconstruction of a scene by rendering one or more images of a planar object on which there are no prior known points or patterns or visually identifiable points or patterns within the scene and without need of any knowledge of the position of the camera within the scene.

2. The system of claim 1, wherein at least one digital image of the scene is rendered with at least one optical disc such as a compact disc, DVD or Blu-ray disc of standard size placed within the scene and similar camera settings are used for all of the at least one digital images rendered.

3. The system of claim 2, wherein the at least one optical disc in the at least one image is placed on an identifiable flat rectangular surface, coincident with or parallel to the ground surface of the scene and in which the rectangular surface is fully enclosing of the at least one optical disc in the at least one image.

4. The system of claim 3, wherein the user after rendering the at least one image can upload or otherwise enter the at least one image to the system using one or more of the following methods: any manner of inter-networked or networked connection; manually inputting the image to the system.

5. The system of claim 3, wherein the system may reside entirely on a single processing platform or be distributed across client and server platforms.

6. The system of claim 3, wherein information including any of camera calibration information, camera parameters, and scene metric information associated with each of the at least one digital images can be uploaded or otherwise entered into the system.

7. The system of claim 3, wherein the system prompts the system user to select the corner vertices of the rectangular surface in at least one of the at least one images uploaded or otherwise entered into the system and the system assists the user in corner selection by having a magnify and zoom feature.

8. The system of claim 7 wherein radial distortion parameters are obtained for the imaging device using at least one of the images rendered.

9. The system of claim 8 wherein obtaining the radial distortion parameters of the camera device comprises:
detecting the boundary of the rectangular surface using the user identified corners of the rectangular surface in at least one of the at least one images rendered;
fitting a model of radial distortion to the detected boundary of the rectangular surface.

10. The system of claim 9, wherein the obtained radial distortion parameters are used to correct the radial distortion in all of the at least one images of the optical disc and the corners of the rectangular surface.

11. The system of claim 10, wherein the boundary of the optical disc is detected in each of the at least one images using edge detection techniques.

12. The system of claim 11, wherein the detected boundary of the optical disc in each of the at least one images is fitted to the conic that gives a best fit according to some criterion of closeness.

13. The system of claim 12 wherein the user selection and quantization error in the selection of the vertices of the rectangular object in each of the at least one images is corrected.

14. A method of the system of claim 13 for correcting the user selection and quantization error in the selection of the vertices of the rectangular object in each of the at least one images comprising:
finding sets of four image points each of which is within a certain proximity of one of the user selected corners of the rectangular surface such that the pair of points resulting from the intersections of opposite sides of the closed quadrilateral formed by the points within a certain proximity of the user selected corners of the rectangular surface are conjugate with respect to the conic formed by fitting the detected boundary of the optical disc to a conic;
for each set of four image points found, each of which is within a certain proximity of one of the user selected corners of the rectangular surface as described in the immediate paragraph above, finding the implied circular points as the intersection of the line defined by the pair of conic conjugate points resulting from the intersections of opposite sides of the closed quadrilateral formed by the set of four image points with the conic resulting from fitting the detected boundary of the optical disc to a conic;
deriving the implied conic dual of circular points to within a similarity for each pair of implied circular points;
deriving the implied inverse to within a similarity of the planar transformation from optical disc plane to image plane for each implied conic dual of circular points;
applying a projective transformation comprising the implied inverse to within a similarity of the planar transformation from optical disc plane to image plane to the conic resulting from fitting the detected boundary of the optical disc to a conic;
fitting the points resulting from applying the implied inverse to within a similarity of the planar transformation from optical disc plane to image plane to the nearest circle according to some measure of closeness;
deriving the corrected corner vertices of the rectangular object as the set of four points each within a certain proximity of the user selected points that gives the best fit to a circle according to the measure of closeness in the immediate paragraph of claim 14 above.

15. The system of claim 14 where the vanishing line of the plane on which the optical disc lies in each of the least one images is obtained from the corrected vertices of the rectangular object.

16. The system of claim 15, wherein orthogonal line pairs are derived using the vanishing line of the plane of the optical disc within each of the at least one images and the conic dual of circular points is derived using the orthogonal line pairs.

17. The system of claim 16, wherein full Euclidean reconstruction of the plane containing the optical disc within each of the at least images is derived.

18. The system of claim 17, wherein the planar homography between the plane of the optical disc and the at least one image is derived.

19. The system of claim 18, wherein at least three images are rendered and camera calibration of and full metric reconstruction of the scene is achieved.

20. The system of claim 18, wherein a model of a two dimensional object is projectively mapped into at least one image to lie on the plane of the optical disc using the Euclidean knowledge of the plane obtained.

21. The system of claim 19, wherein a model of a three dimensional object is projectively mapped into at least one of the at least three images using the camera internal calibration, camera pose and scene Euclidean reconstruction information obtained.

22. The system of claim 19, where the vanishing point in the vertical direction is obtained in one or more of the least one images using the derived internal calibration parameters of the camera and the image of the rectangular surface and optical disc.

23. The system of claim 22, wherein a enclosed vertical box can be constructed around any three dimensional object within the scene for the purpose of computing occlusions to resulting from the object relative to the object to be inserted into the scene.
